(19) United States
(12) Patent Application Publication
(10) Pub. No.: US 2007/0208589 A1
(43) Pub. Date: Sep. 6, 2007

(54) Methodology for Recruiting and Retaining Employees for Temporary Staffing Companies

(76) Inventors: David Kugler, Brookeville, MD (US); Carol Ann Kugler, Brookeville, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/673,741

(22) Filed: Feb. 12, 2007

Related U.S. Application Data
(60) Provisional application No. 60/775,344, filed on Feb. 22, 2006.

(51) Int. Cl. G06Q 10/00; G06Q 30/00

(52) U.S. Cl. 705/1

(57) ABSTRACT

A computer-implemented method is provided for encouraging referrals of persons for employment. Information is stored that identifies each of a plurality of referring parties, that is, information identifying persons or entities that refer a person or entity that is a candidate for a position at an employer party. The person or entity that is referred as a candidate is called a referred party. The referring party supplies the referred party information. When the referred party is placed in a position with an employer, the work performed over time by the referred party at the employer party is tracked and stored. A royalty owed to the referring party based on the work performed by the referred party is then computed. The royalty may be computed on a periodic basis based on the amount of work performed by the referred party during a time interval.

### RELATED APPLICATION

This application claims priority to U.S. Provisional Application No. 60/775,344 filed Feb. 22, 2006, the entirety of which is incorporated herein by reference.

### BACKGROUND OF THE INVENTION

In the field of temporary labor staffing, it has been found by agencies and companies that provide temporary or part-time staffing for third parties that the best and most quality directed method of attracting new personnel is through referral by other qualified individuals. While it has been the customary practice of some temporary labor staffing companies to pay the referring individual a one time “referral bonus” after the referred individual has successfully completed a specific number of shifts, it has never been the practice to pay any type of “on-going bonus” for the referral. Because the referring individual has shown an ability to encourage the referred individual to work for the company for a pre-specified period of time or indefinitely, it makes sense for the company to provide incentive for the referring individual to continue to encourage the referred individual to continue to work for the company.

### SUMMARY OF THE INVENTION

Briefly, a method that can be implemented via computer is provided for encouraging referrals of persons for employment. Information is stored that identifies each of a plurality of referring parties, that is, information identifying persons or entities that refer a person or entity that is a candidate for a position at an employer party. The person or entity that is referred as a candidate is called a referred party. The referring party supplies the referred party information. When the referred party is placed in a position with an employer, the work performed over time by the referred party at the employer party is tracked and stored. A royalty owed to the referring party based on the work performed by the referred party is then computed. The royalty may be computed on a periodic basis based on the amount of work performed by the referred party during a time interval.

Thus, the system and method according to the present invention generates a payment amount to the referring party as a pro rata share or percentage of the amount of work performed by the referred party on an ongoing basis. The measure of the work performed may be in terms of hours worked (and reported by the employer party), amount of sales made, number of deals closed, etc. The royalty rate may be based on the skills required for a particular position and can therefore vary for different employer parties, or across positions for the same employer party.

### BRIEF DESCRIPTION OF THE DRAWINGS

FIG. 1 is a block diagram of a system according to an embodiment of the invention.

FIG. 2 is a flow chart according to an embodiment of the invention.

FIG. 3 is a diagram showing an example of data storage and computations according to an embodiment of the invention.

### DETAILED DESCRIPTION

According to the invention, a person (referring party) who refers a candidate for temporary or contract employment (referred party) to a staffing agency or company (staffing company), which provides staffing to third party organizations (called employer parties herein), receives payment from the staffing company as a function of the amount of time worked (or amount of billings generated) by the referred party to third party organizations via the staffing company on an ongoing basis for as long as the referred party continues to provide such services through the staffing company. For example, the referring party may receive a pro rata share of the hourly billings or earnings of the referred party. Similarly, the referring party can essentially receive a royalty for the time worked by the referred party or revenue generated by the referred party (e.g., the referring party receives a royalty of 25¢ from the staffing company for every hour of service provided by the referred party to third party organizations via the staffing company). In this manner, the staffing company ultimately pays the referring party an amount that is substantially proportionate to the financial benefit derived from the referred party over time. Likewise, referring parties are provided with a greater incentive to seek out candidates that are likely to work a substantial number of hours and/or remain with the staffing company for a considerable period of time, and have an ongoing incentive to encourage a continuing relationship between the referred party and the staffing company. The invention is not limited to any particular type of work provided, any type of third party organization receiving the services, or any type of work arrangement (e.g., temporary, part-time, full-time on a contract basis, etc.).

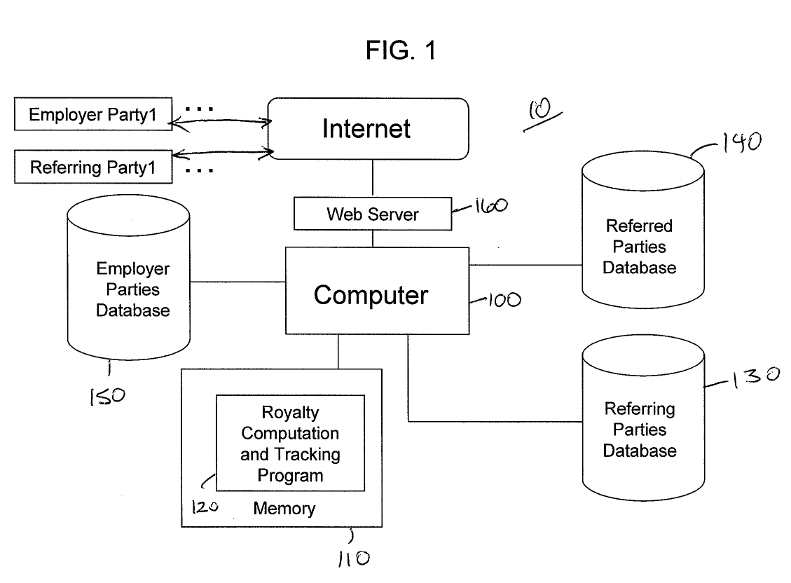

Referring first to FIG. 1, a block diagram depicting the system 10 according to an exemplary embodiment of the present invention will be described. A computer 100 is provided that operates on one or more computer programs stored in a computer readable medium, i.e., memory 110. In particular, in the memory 110 there is a computer program that performs the work performance tracking and royalty computations according to the embodiments of the invention. This program is called the royalty computation and tracking program and is shown at reference numeral 120. It is executed by the computer 100 to perform the various aspects of the invention described herein.

The computer 100 interfaces with data stored in one or more databases. For example, there is a referring parties database 130 that contains data associated with referring parties. The referring party database 130 contains name, address and other information necessary to identify each referring party. In addition, the computer 100 may assign an identifier (e.g., number, numbers plus letters, etc.) to each referring party. The referred parties database 140 contains data associated with referred parties, and in particular, name, address and other information associated with each referred party who is supplied to the system 10 by a referring party, where the referred party is a candidate for a position at an employer entity by and through a staffing company. There is also an employer parties database 150 that stores data associated with employer parties. The employer parties may be, but are not limited to, persons or businesses with which a staffing agency has a relationship for placing individuals in positions on a temporary or permanent basis. It should be understood that the databases 130, 140 and 150 may be combined and implemented in a single database and use any database software technology now known or hereinafter developed. Furthermore, it should also be understood that is not necessary to use database software techniques to build and operate a system according to the present invention.

The computer 100 may reside in an office or facility operated by a staffing company, or at a third party facility that performs the royalty tracking computations on behalf of one or more staffing companies. Communication of data to and from the computer 100 (with respect to a referring party and an employer party) may be by way of email or web page forms via the Internet, or by phone or in person discussions. Thus, a web server application is shown at 160 that is one example of an interface between the computer 100 and employer parties and referring parties, but implementation need not be web-based. For example, the implementation may involve a spreadsheet application where the data is entered into a spreadsheet and the spreadsheet performs the necessary calculation.

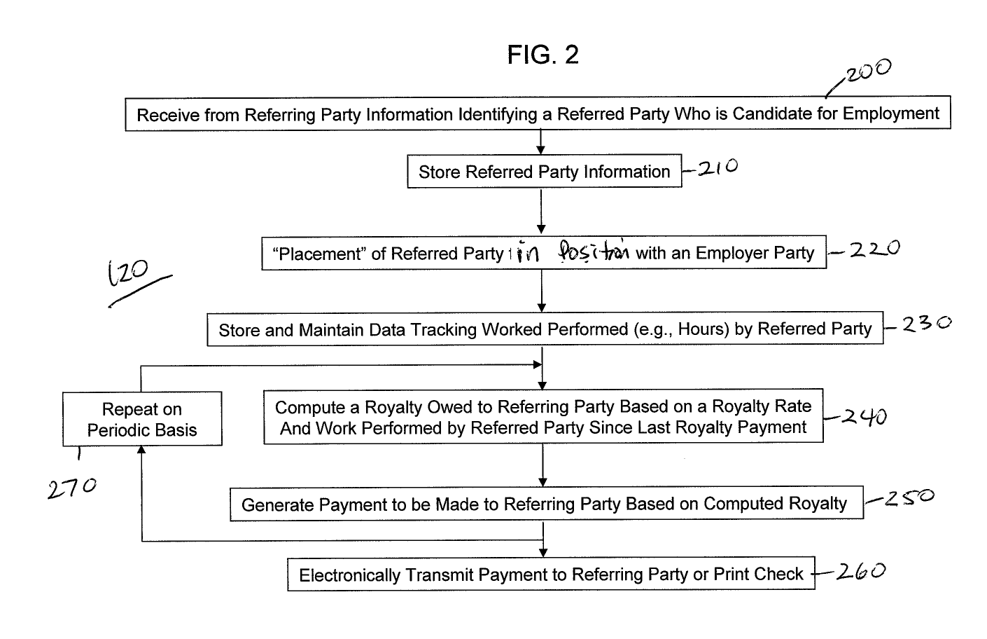

Turning now to FIG. 2, a flow chart representing operation of the royalty computation and tracking program 120 executed by the computer 100 is described according to one embodiment. At 200, the computer 100 receives information from a referring party identifying a referred party who is a candidate for employment, that is, for “placement” with an employer entity. The referring party may supply the information for a referred party by way of email, website form pages, telephone, in person discussion, etc. At 200, if the referring party is not already known to the system 10, then the computer 100 also stores information identifying the referring party. At 210, the computer 100 stores the referred party information received at 200. The system 10 may receive information for new referred parties at any time and on an ongoing basis.

The staffing or other company that uses the system 10 then performs the necessary interviews of each referred party, review of the referred party's resume, qualifications and employment references, as well as perform any of the other necessary background checks as is customary in the particular field. The staffing company will also determine which of the employer entities has a position most suited for the referred party. When such a position is identified, the referred party is made to interview with the employer party for the position. Ultimately, at 220, when the employer party accepts the referred party for the position, the referred party is “placed” in the position with the employer party.

The employment may be temporary, temporary with possibility to permanent, or permanent, as well as full-time or part-time. There is typically a contractual relationship between the staffing company and the employer party with respect to compensation owed to the staffing company for finding and placing the referred party in the position. Furthermore, the referred party may be “placed” to work with more than one employer party (at the same time). For example, nurse staffing in hospitals is managed on a “per diem” basis where a particular nurse may work for different hospitals on different days. In some situations, the staffing company pays the referred party and bills the employers such that the employers pay the staffing company for services. However, the present invention is not limited to use in these type of situations; the employer may pay referred party directly, and then report the hours paid for to the staffing company.

After the referred party is “placed” with an employer party, at 230 the system stores and maintains data tracking the work performed by the referred party at the employer party. The manner in which the system 10 receives information from the employer party concerning work performed by the referred party may vary. For example, the employer party may send (by postage, email or web page forms) data detailing the number of hours worked by the referred party. Upon receiving this data, the computer 100 stores the data.

Next, at 240, the computer 100 computes a royalty owed to the referring party that supplied information about the referred part to the system 10. The royalty computation may be performed on a periodic basis upon the expiration of a time interval, such as a week, two weeks, month, quarter, or year. In making the royalty computation, the computer 100 retrieves the applicable royalty rate and multiplies it by a measure of the work performed by the referred party. In one embodiment, the royalty computation involves multiplying a number of hours worked for the time interval by a royalty rate (per hour). However, the present invention is not limited to such an hourly royalty computation and may be based on days, weeks, months or years that the referred party works for the employer party. Moreover, the royalty calculation need not be based on the amount of time worked by a referred party. For example, the referred party may perform duties that are measured in other means such as amount of sales, number of deals closed, etc., and the computer 100 would assign and store a royalty rate that is based on the work contribution that is being tracked and measured on an ongoing basis.

At 250, the computer 100 generates a payment to be made to the referring party based on the royalty computation at 240. The payment so computed may be involve automatically printing a check made out to the referring party, or as indicated at 260, the payment may be electronically transmitted to the referring party using any of a variety of known electronic payment technologies, such as the PayPal® service, on-line banking payment services, etc. The computation at 240 is repeated on a periodic (or on demand) basis as shown at 270 after the end of a predetermined time interval for each of a plurality of cycles of the predetermined time interval.

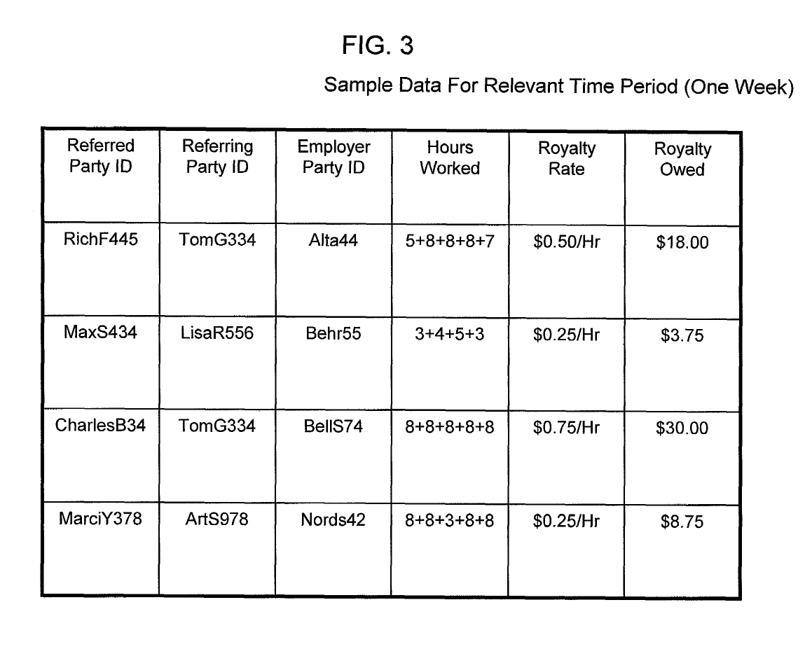

FIG. 3 illustrates exemplary data that is accumulated over time by the computer 100. The specific organization of the data shown in FIG. 3 is by way of example only and not intended to limit the present invention in any way. Moreover, the table shown in FIG. 3 shows that the work contribution that is tracked is hours worked, but this again is only by way of example. Each row of the table tracks the work contribution made by a referring party at a particular employer. For example, the first row of the table shows an identifier for a referred party “RichF445” and an identifier for the referring party “TomG334”. The data in the first row is interpreted to mean that TomG334 referred to the system 10 RichF445 and RichF445 was placed at an employer assigned the identifier Alta44. For the time interval associated with the data shown in the table (one week), the system 10 tracked that RichF445 worked a total of 37 hours for that week. The royalty rate that the system 10 assigned to this transaction is $0.50/Hr, so the system computes the total royalty owed to TomG334 is $18.00 for the work performed by RichF445 at employer Alta44. The second row in the table indicates that LisaR556 referred MaxS434 to the system 10 who was placed with employer Behr55, and for the week reported by the table, MaxS434 worked 15 hours. The system 10 computes a royalty owed to LisaR556 of $3.75 (at a royalty rate of $0.25/Hr) for the work performed by MaxS434. The third row shows that TobG334 also referred ChalesB34 who performed 40 hours of work at employer BelIS74, and is owed a royalty of $30.00 based on a royalty rate of $0.75/Hr.

The table shown in FIG. 3 further indicates that the system 10 may assign a different royalty rate for different employer parties and/or referred parties. For example, the position into which a referred party is placed may involve a certain set of skills that, based on market conditions, justifies a higher compensation to the referring party because referred parties with those skills are more difficult to find than referred parties for other positions. In addition, the computer 100 may store data for a plurality of referring parties, where each referring party may supply information for one or more referred parties who are candidates for positions to be placed by a staffing agency. The staffing or other company that operates the system 10 decides and sets the royalty rate that is appropriate, reflecting the pro rata share allocated to the referring party.

It should be understood that term “referred party” may mean an individual person or an entity (corporation, company, etc.). The same holds for the meaning of the term “referring party” and “employer party” or “employer entity”.

The above description is intended by way of example only.

What is claimed is:

1. A method for encouraging referrals of persons for employment, comprising:
a. storing referred party information that identifies a referred party who has been referred by a referring party and who is a candidate for a position with an employer entity;
b. tracking work performed over time by the referred party at the employer entity and storing work data representative thereof;
c. computing a royalty owed to the referring party based on the work performed by the referred party.

2. The method of claim 1, wherein storing work data comprises storing number of hours worked by the referred party at the employer party.

3. The method of claim 2, wherein computing comprises computing the royalty by multiplying a royalty rate and the number of hours worked by the referred party.

4. The method of claim 3, and further comprising storing referred party data for a plurality of referred parties that are referred by a referring party for work at one or more of a plurality of employer parties, and wherein the royalty rate may vary for different employer parties.

5. The method of claim 1, and further comprising electronically transmitting a payment to the referring party.

6. The method of claim 1, and further comprising storing referring party data identifying each of a plurality of referring parties, and associating with referring party data work data for work performed by a referred party that was identified and supplied by the corresponding referring party.

7. A method for compensating a referring party that refer persons for employment, comprising:
a. receiving from a referring party a referral for a referred party who is a candidate for a position with an employer entity;
b. storing referred party information identifying a referred party;
c. storing work contribution data that tracks work contributions made by the referred party at the employer party; and
d. based on said contribution data, computing a royalty owed to the referring party in order to compensate the referring party for referring the referred party.

8. The method of claim 7, wherein (c) storing comprises storing work contribution data that comprises number of hours worked by the referred party at the employer party.

9. The method of claim 8, wherein computing comprises computing the royalty by multiplying a royalty rate and the number of hours worked by the referred party.

10. The method of claim 7, and further comprising storing referring party data identifying a referring party, and associating with referring party data work contribution data for work contributions made by the referred party that was identified and supplied by the corresponding referring party.

11. The method of claim 7, wherein receiving comprises receiving a referral from a plurality of referring parties.

12. The method of claim 11, and further comprising storing referring party data identifying each of the plurality of referring parties, and associating with referring party data work contribution data for work contributions made by a referred party that was identified and supplied by the corresponding referring party.

13. The method of claim 7, and further comprising generating payments to be made to a referring party based on the computed royalty.

14. The method of claim 13, and further comprising electronically transmitting a payment to the referring party.

15. The method of claim 7, wherein (c) storing comprises accumulating work contribution data for work contributions made by a referred party over a time interval, and wherein after said period of time said computing is performed to compute the royalty owed to said referring party for said time interval.

16. The method of claim 15, wherein said storing is performed on an ongoing basis over multiple cycles of said time interval.

17. A computer readable medium storing instructions, that when executed by a computer, cause the computer to:
a. store referred party information that identifies a referred party who has been referred by a referring party and who is a candidate for a position with an employer entity;
b. track work performed over time by a referred party at the employer entity and store work data representative thereof;
c. compute a royalty owed to the referring party based on the work performed by the referred party.

18. The computer readable medium of claim 17, wherein the instructions that cause the computer to store comprise instructions, that when executed, cause the computer to store referring party data identifying each of a plurality of referring parties, and associate with referring party data work data for work performed by a referred party that was identified and supplied by the corresponding referring party.

19. The computer readable medium of claim 17, wherein the instructions that cause the computer to store comprises instructions for storing the number of hours worked by the referred party at the employer party.

20. The computer readable medium of claim 19, wherein the instructions that cause the computer to compute the royalty comprise instructions that cause the computer to multiply a royalty rate and the number of hours worked by the referred party.
